(19) United States
(12) Patent Application Publication
(10) Pub. No.: US 2009/0055873 A1
(43) Pub. Date: Feb. 26, 2009

(54) ADVERTISEMENT-FREE PROGRAM RECORDING METHOD AND SYSTEM FOR MOBILE DEVICE

(75) Inventors: Jeong Hoon KIM, Gumi-si (KR); Seong Geun Kwon, Metropolitan City (KR); Jong Kerl Lee, Gumi-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/196,963

(22) Filed: Aug. 22, 2008

(30) Foreign Application Priority Data
Aug. 22, 2007 (KR) 2007-0084367

(51) Int. Cl. G06F 3/00

(52) U.S. Cl. 725/58

(57) ABSTRACT

An advertisement-free program recording method and system is provided for recording a broadcast program excluding advertisement breaks. A program recording method of the present invention includes reserving a duration of time or program to be recorded; receiving broadcast data in the duration; recording the received broadcast data; determining whether advertisement data is detected in the received broadcast data; stopping recording the broadcast data when advertisement data is detected; and restarting recording the broadcast data when no advertisement data is detected.

### PRIORITY

This application claims priority under 35 U.S.C. § 119(a) to a Korean Patent Application filed in the Korean Intellectual Property Office on Aug. 22, 2007 and assigned Serial No. 2007-0084367, the contents of which are incorporated herein by reference.

### BACKGROUND OF THE INVENTION

1. Field of the Invention

The present invention relates to a broadcast system and, in particular, to an advertisement-free program recording method and system for a broadcast-enabled mobile device capable of recording a broadcast program without commercial advertisement breaks.

2. Description of the Related Art

A digital broadcast receiver is an apparatus that restores original digital data received from a broadcast signal transmitted by a broadcast station. The digital data is coded and modulated so as to be broadcasted in the form of a broadcast signal by the broadcast station. The digital broadcast receiver demodulates and decodes the broadcast signal for restoring the original digital data. Accordingly, the digital broadcast receiver is provided with a tuner, a demodulator, and a decoder. Recent digital broadcast systems are classified into a digital multimedia broadcast (DMB) system and a digital video broadcasting (DVB) system. Both digital broadcast systems provide a plurality of service channels in a frequency bandwidth and each service channel is structured with multiplexed sub-channels of video, audio, and program information data.

In the meantime, recent mobile phones are equipped with a dedicated multimedia processor and various multimedia functions, and the digital broadcast receiver is becoming one of the most popular multimedia modules integrated into the recent mobile phones.

A dedicated digital broadcast receiver or a mobile terminal equipped with a digital broadcast module receives broadcast program information together with audio and video data which are processed by corresponding decoders. The broadcast program information can be Electronic Program Guide (EPG) in the DMB system and Electronic Service Guide (ESG) in DVB system. In the ESG system, various service data is stored in addition to the program information.

Typically, the program data are broadcasted with commercial advertisements. This is, the commercial advertisements are inserted between programs and/or in the middle of a program. Accordingly, a viewer is often interrupted by the advertisements while watching the program.

In many cases, the viewer wants to skip the commercial advertisements to continuously watch the ongoing program. The desire to skip the advertisements increases when the viewer records a specific program.

### SUMMARY OF THE INVENTION

The present invention has been made to solve the above problems. The present invention provides an advertisement-free program recording method and system for a mobile device that is capable of recording a broadcast program without commercial advertisement breaks.

In accordance with an aspect of the present invention, a program recording method includes reserving a duration of time or program to be recorded; receiving broadcast data in the duration; recording the received broadcast data; determining whether advertisement data is detected in the received broadcast data; stopping recording the broadcast data when advertisement data is detected; and restarting recording the broadcast data when no advertisement data is detected.

In accordance with another aspect of the present invention, a program recording method includes receiving and outputting broadcast data; detecting a recording key input while receiving and outputting the broadcast data; determining, when an advertisement skip option is on, whether a reception of advertisement data is detected; stopping, when a reception of advertisement data is detected, recording the broadcast data; and restarting, when the reception of the advertisement data ends, recording the broadcast data.

In accordance with still another aspect of the present invention, a mobile device includes a broadcast receiver unit for receiving broadcast data; a control unit for recording program data of the broadcast data from which advertisement data are excluded; and a memory unit for buffering the broadcast data and storing selectively the program data.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram illustrating a configuration of a mobile device according to a preferred embodiment of the present invention;

FIG. 2 is a diagram illustrating a data format for use in an advertisement-free program recording method and system according to a preferred embodiment of the present invention;

FIGS. 3A to 3E are diagrams illustrating steps of an advertisement-free program recording method according to a preferred embodiment of the present invention;

FIG. 4 is a flowchart illustrating an advertisement-free reserved program recording method according to a preferred embodiment of the present invention; and

FIG. 5 is a flowchart illustrating an advertisement-free real time program recording method according to another preferred embodiment of the present invention.

### DETAILED DESCRIPTION OF PREFERRED EMBODIMENTS

Preferred embodiments of the present invention are described with reference to the accompanying drawings in detail. The same reference numbers are used throughout the drawings to refer to the same or similar parts. Detailed descriptions of well-known functions and structures incorporated herein may be omitted to avoid obscuring the subject matter of the present invention.

The terms and phrases used in the specification and appended claims are provided to enable a clear and consistent understanding of the detailed description and the claims. Unless otherwise noted, the terms and phrases are to be understood according to conventional usage by those skilled in the relevant art.

In the following, the advertisement-free program recording method and system is described in connection with a mobile device supporting digital broadcast service and capable of buffering and storing broadcast data. The mobile device can be any of Code Division Multiple Access (CDMA) terminal, Personal Digital Assistant (PDA), Smartphone, 3^{rd} Generation (3G) terminal including Wideband CDMA (WCDMA) terminal, CDMA2000 terminal, Global System for Mobile communications (GSM) terminal, General Packet Radio System (GPRS), and their equivalent information processing devices.

The mobile device can be implemented to support various digital broadcast services such as Satellite DMB (S-DMB), Terrestrial DMB (T-DMB), DVB-Handheld (DVB-H), and DVB-Terrestrial (DVB-T).

The broadcast program is produced and broadcasted by a broadcast station, and commercial advertisements are arranged at the beginning and end of the program and/or in the middle of the program.

Although the advertisement-free program recording method and system is described in association with a mobile device, the present invention is not limited thereto. For example, the advertisement-free program recording method and system can be applied to any type of mobile and fixed terminals.

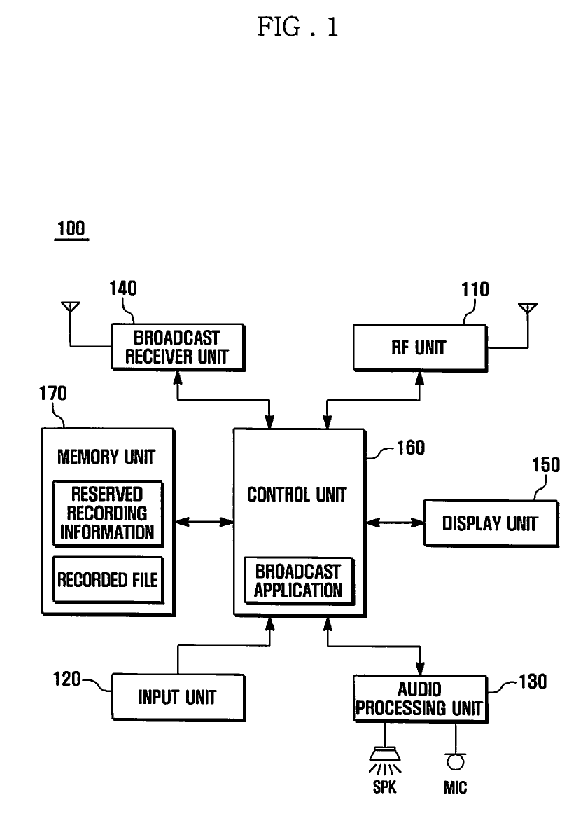

FIG. 1 is a block diagram illustrating a configuration of a mobile device according to a preferred embodiment of the present invention.

Referring to FIG. 1, the mobile device 100 includes a Radio Frequency (RF) unit 110, an input unit 120, an audio processing unit 130, a broadcast receiver unit 140, a display unit 150, a control unit 160, and a memory unit 170.

The RF unit 110 is responsible for radio communication of the mobile device under the control of the control unit 160. The RF unit 110 includes an RF transmitter for up-converting and amplifying the transmission signal and an RF receiver for low noise amplifying and down-converting the received signal.

More specifically, the RF unit 110 can be configured to maintain its active state, while the mobile device 100 is receiving the broadcast signal, and preferentially inform the control unit 160 of a detection call request event and reception of a message.

The input unit 120 is provided with a plurality of alphanumeric keys for receiving alphanumeric data input by a user and a plurality of function keys for executing various functions of the mobile device. The function keys can be implemented in the forms of navigation keys, side keys, and shortcut keys. The input unit 120 generates key signals corresponding to the keys input for configuring and controlling the mobile device and transmits the key signals to the control unit 160.

More specifically, the input unit 120 generates program recording key signals and reserved program recording key signals and transmit the generated key signals to the control unit 160. More particularly, the input unit 120 generates a reserved program recording command, a real-time program recording command, an advertisement skip command, and a recorded program playback command, and transmit the commands to the control unit 160.

The audio processing unit 130 is provided with a speaker (SPK) for outputting an audio signal and a microphone (MIC) for receiving an audio signal including voice. The audio signal output from the SPK is decoded audio data transmitted from the control unit 160 in the form of an audible sound wave. Specifically, the audio processing unit 130 outputs an alert sound for alerting the start of program recording according to a user configuration. That is, if a program recording or reserved program recording is started, the audio processing unit 130 outputs the alert sound for alerting at the beginning of the program recording.

The broadcast receiver unit 140 is configured to receive the broadcast data from a broadcast station. The broadcast receiver unit 140 can be a receiver module compatible with a broadcast standard adopted by the broadcast station. For example, the broadcast receiver unit 140 can be a DMB module for receiving the DMB service or a DVB module for receiving the DVB service. Also, the broadcast receiver unit 140 can be a DVB-H module for receiving the DVB-H service. The broadcast receiver unit 140 receives the broadcast data including the broadcast programs and advertisements and transmits the broadcast data to the memory unit 170 and/or display unit 150 under the control of the control unit 160. In the meantime, the broadcast receiver module 140 responds to a recording option input by the user to record a specific program on a specific channel under the control of the control unit 160.

The display unit 150 displays various screens in connection with the operations of the mobile device 100, such as a broadcast playback screen, a standby mode screen, a menu screen, and a communication status screen. The display unit 150 can be implemented with a Liquid Crystal Display (LCD). In this case, the display unit 150 may include an LCD controller, a video memory for buffering the video data, and LCD devices. If the LCD supports a touch screen function, the display unit 150 can act as a part of the input unit 120.

More specifically, the display unit 150 displays the program data and advertisement data extracted from the broadcast data received by the broadcast receiver module 140. In the case of the program recorded with an advertisement skip option, only the program data are recorded such that the display unit 150 displays the program data without the commercial. The display unit 150 also provides a recording configuration interface for allowing the user to set the recording and reservation options. The recording configuration interface is described later in more detail.

The memory unit 170 stores application programs required for operating various functions of the mobile device 100. The application programs include a broadcast playback application for controlling the reception and playback of the broadcast data. The memory unit 170 also buffers the broadcast signal received by the broadcast receiver unit 140. The memory unit 170 can be divided into a program region and a data region.

The program region stores the operating system (OS) for booting up the mobile device 100 and application programs, such as messaging service program, audio playback program, and video playback program. More specifically, the program region stores a mobile broadcast program required for managing the reception and playback of the broadcast data. The program region loads the application programs in response to the user command and the application programs operate under the control of the control unit 160.

The data region stores application data generated while the application programs are running and user data input by the user. More specifically, the data region buffers the real time broadcast data and stores the recorded broadcast program. The data region also stores the user data relevant to the optional function of the mobile device 100 such as the phonebook data, multimedia contents, and settings. The data region also stores reserved recording information on the broadcast program that is to be recorded. The reserved recording information includes start and end times of the reserved program and the skip option. The control unit 160 controls the process of recording according to the reserved recording information.

The control unit 160 controls general operations and signaling between the internal elements of the mobile device 100. The control unit 160 activates the broadcast application in response to the user command and configures the mobile device to receive the broadcast data on the service channel selected by the user. The control unit 160 checks the memory to determine whether any reserved recording information exists. If any reserved recording information exists, the control unit 160 controls the broadcast receiver unit 140 and the memory unit 170 with reference to the reserved recording information such the reserved program is recorded in the memory unit 140. The program recording can be performed in real time and according to the reserved recording information.

The reserved program recording is performed with reference to the reserved recording information set by the user. The reserved recording information can be set on a recording settings screen. The recording settings screen allows the user to select a program to be recorded and/or scaling the time duration in which the program is recorded. If a program is reserved to be recorded, the control unit 160 acquires the recording start timing by using a timer or by comparing the current time with the broadcast time of the reserved program. If the start timing is set, the control unit 160 activates the broadcast receiver module 140 and sets the service channel with reference to the reserved recording information. In order to start recording at an accurate time, preferably, the control unit 160 sets the start time taking into account the processing delay. At this time, the control unit 160 checks whether the advertisement skip option is active. When the advertisement skip option is on, the control unit 160 skips recording the advertisement. The advertisement skip operation is described later in more detail. When the start timing of the reserved program recording is set, the control unit 160 controls a recording start alert output through the display unit 150 and/or the audio processing unit 130. In order to reduce the power consumption, the reserved program recording is performed as a background process without displaying the program data on the display unit 150.

In the real time recording, the live onscreen broadcast data are recorded in real time. That is, the real time recording is started in response to a recording key input by the user while viewing a program currently being broadcasted. At this time, the control unit 160 checks whether the advertisement skip option is active. If the advertisement skip option is on, the control unit 160 controls the program recording stopping at the start time of the advertisement and restarting at the end time of the advertisement.

As described above, the advertisement-free program recording method and system can optionally skip recording advertisement data while recording real time broadcast program and reserved broadcast program, thereby improving user convenience and device utilization.

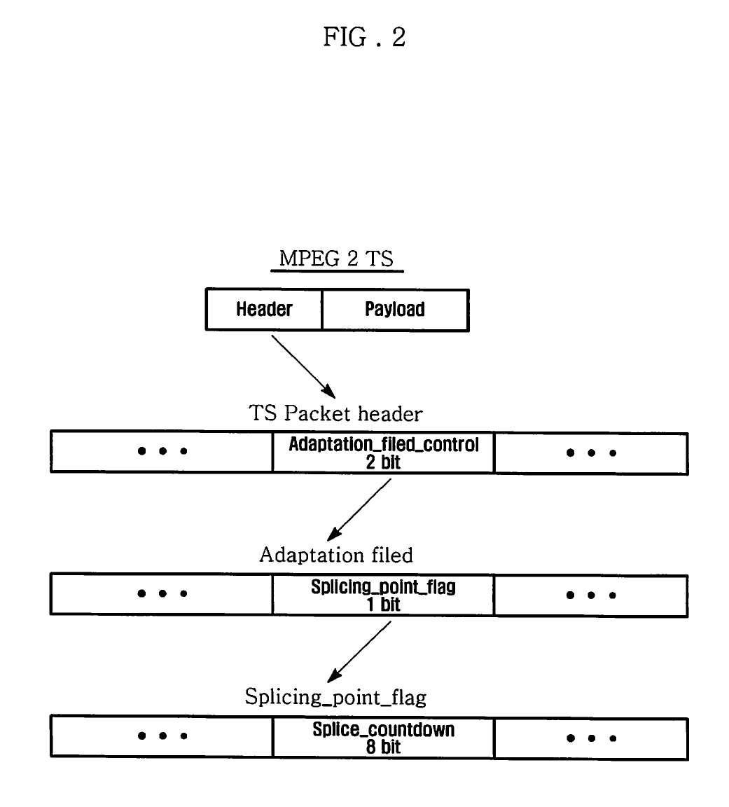

FIG. 2 is a diagram illustrating a data format for use in an advertisement-free program recording method and system according to a preferred embodiment of the present invention. In this embodiment, the advertisement-free program recording method and system is described in connection with an MPEG2 Transport Stream (MPEG2-TS) packet. However, the present invention is not limited thereto.

Referring to FIG. 2, a data packet transmitted by the broadcast station is composed of a packet header and a payload. The payload contains the program data and advertisement data in the form of bit stream. The packet header contains control information on the data of the payload. The TS packet header includes an Adaptation Field Control (AFC) field for indicating whether the packet header is followed by an adaptation field and/or payload. The AFC field is 2 bits long. The AFC value “00” is reserved for future use; the AFC value “01” indicates no adaptation field and payload only; the AFC value “10” indicates adaptation field only; and the AFC value “11” indicates adaptation field followed by payload.

Accordingly, when the AFC field is set to “10 or “11”, the TS header has the adaptation field. The adaptation field consists of various fields. If a splicing point flag is set, the adaptation field has a splice countdown field. The splice countdown value indicates that another transport stream follows the current transport stream. This indicates that the characteristics of the broadcast data have been changed. In other words, the occurrence of the countdown during the reception of the broadcast program data indicates that an advertisement is contained in the program. The splice countdown is 8 bits long and counts down from 256 packets to 0. When the countdown value reaches0, the mobile device 100 starts playing back the broadcast data. After reproducing the broadcast data with another splice countdown, the mobile device 100 restarts the playback of the program from the end point. As described above, a program recording is started or reserved with the active advertisement skip option. The control unit 160 distinguishes the advertisement data from the program data using the splice countdown value of the packets. Therefore only the program data is recorded with the advertisement data skipped.

The advertisement-free program recording method and system can be implemented using the contents nibble information. Typically, the transport streams of the mobile broadcast system such as DMB and DVB-H have a Program Map Table (PMT) and an audio Packet Identifier (PID), a video PID, and a Service ID (SID). The SID specifies a service relating to a transmission, and the Event Identifier (EID) specifies one of several sets of program information contained in an Event Information Table (EIT). The EID provides a program start time, program duration, a descriptor, and other information. The descriptor includes a contents nibble for indicating a genre of the program. Referring to the EID and contents nibble, the mobile device 100 can detect change of the programs and genres of the programs. Accordingly, the mobile device 100 can distinguish the advertisement data from the program data using the EID and detects the advertisement data in the middle of the program using the contents nibble. That is, the mobile device 100 records the broadcast data having the same EID and the same contents nibble so as to avoid recording the advertisement.

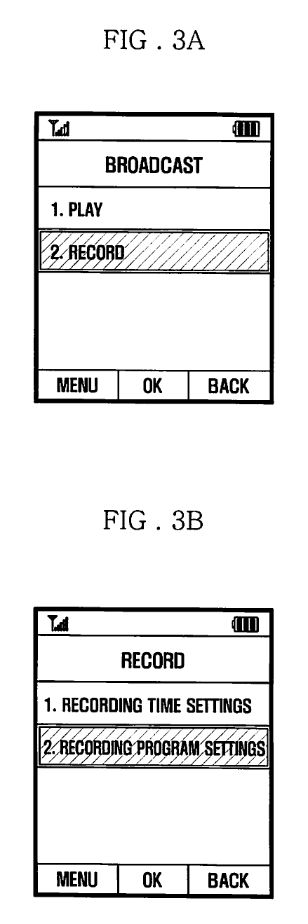

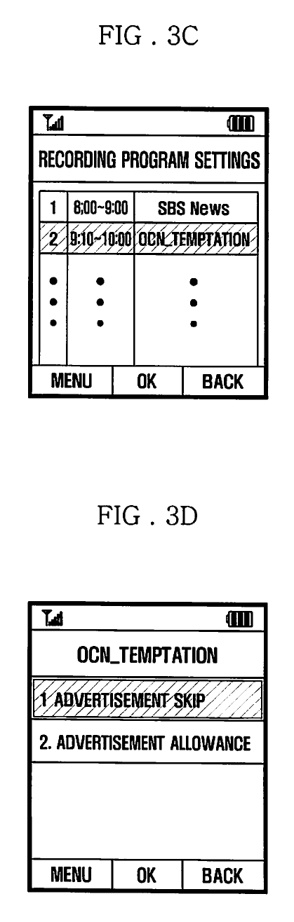

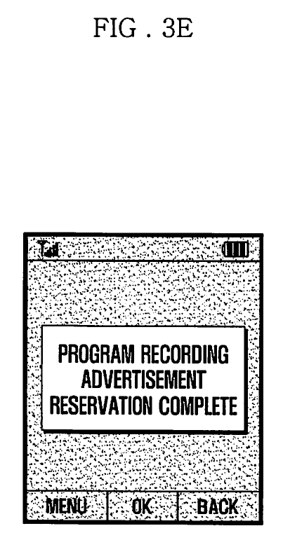

FIGS. 3A to 3E are diagrams illustrating the steps of an advertisement-free program recording method according to a preferred embodiment of the present invention.

Referring to FIGS. 3A to 3E, If a broadcast menu item is selected from a main menu screen, the display unit 150 displays a broadcast menu screen having the “play” and “record” menu items as shown in FIG. 3A. If the “record” item is selected, a record menu screen appears as shown in FIG. 3B. The record menu screen provides “recording time settings” and “recording program settings” items. If the “recording program settings” item is selected, the display unit 150 displays a recording program settings screen as shown in FIG. 3C. The recording program settings screen shows a program schedule with the program indexes such that the user can select the programs using the indexes. In FIG. 3C, the program assigned index “2” is selected. If a program selection key is input, the display unit 150 displays a “recording option” screen as shown in FIG. 3D.

The recording option screen has the title of the selected program and presents an “advertisement skip” and an “advertisement allowance” options. If the “advertisement skip” option is selected, the display unit 150 displays a program recording reservation complete message as shown in FIG. 3E.

As described above, the mobile device 100 acquires information on the advertisement duration in a transport stream with reference to the splice countdown value or from the EID and contents nibble extracted from the packet header and skip the advertisement during the program recording with the active advertisement skip option.

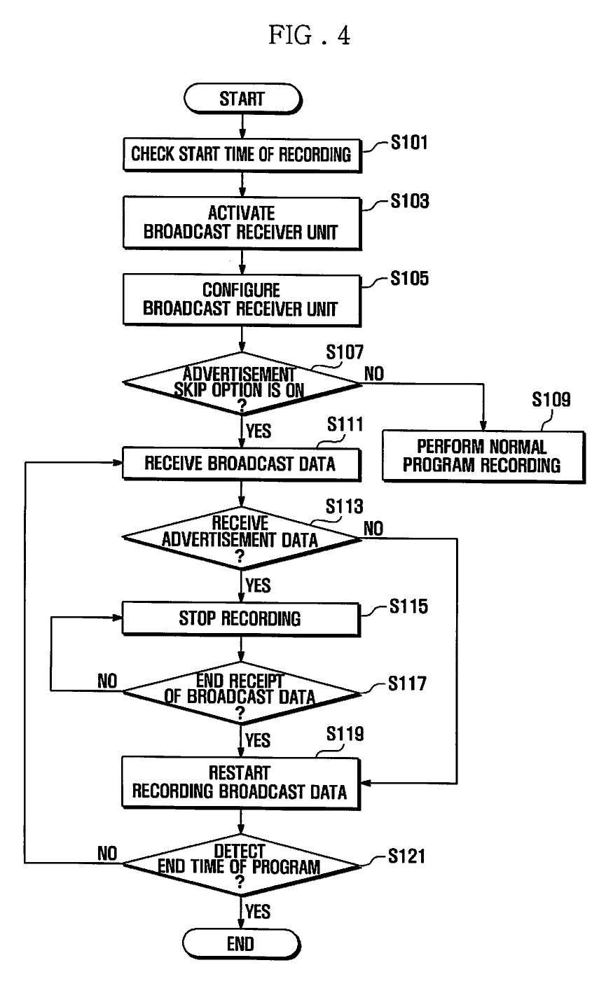

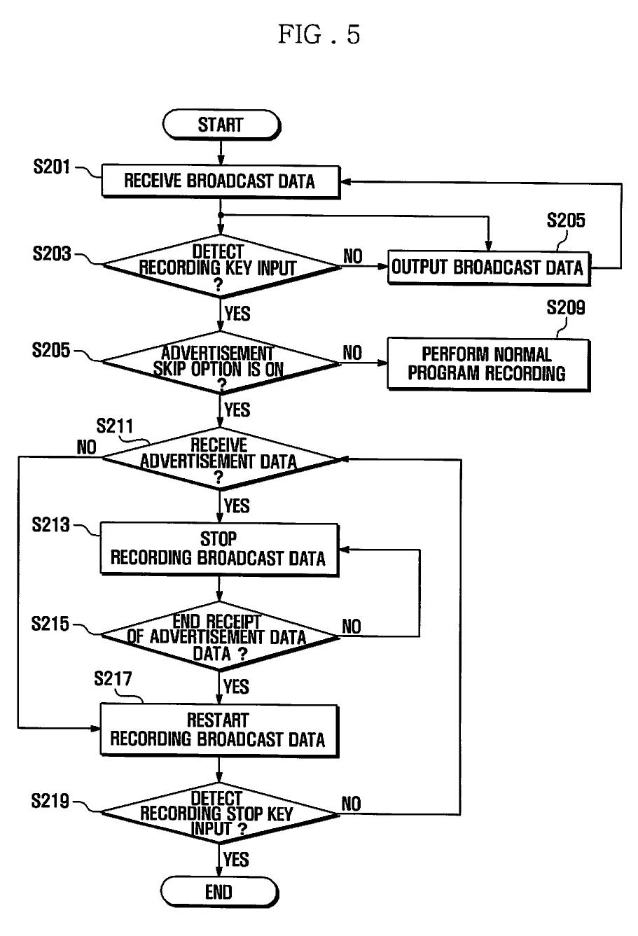

An advertisement-free program recording method according to a preferred embodiment of the present invention is described hereinafter in connection with FIGS. 4-5.

FIG. 4 is a flowchart illustrating an advertisement-free reserved program recording method according to a preferred embodiment of the present invention. In this embodiment, it is assumed that a program is reserved to be recorded.

Referring to FIG. 4, the control unit 160 searches for a recording-reserved program and checks the recording-reserved program in step S101. At this time, the control unit 160 acquires the start time with reference to a timer started when the program is reserved or by comparing the current time with the broadcast time of the reserved program.

Next, the control unit 160 detects the start time of the reserved program and activates the broadcast receiver unit 140 in step S103. Preferably, the control unit 160 activates the broadcast receiver unit 140 earlier than the accurate start time of the program taking into account the delay time required for activating the broadcast receiver unit 140. Once the broadcast receiver unit 140 is activated, the control unit 160 configures the broadcast receiver unit 140 in step S105. That is, the control unit 160 sets the broadcast receiver unit 140 with reference to the channel information and program information included in the program reservation information. After completing the configuration of the broadcast receiver unit 140, the control unit 160 refers to the program reservation information and determines whether the advertisement skip option is active in step S107. If the advertisement skip option is inactive, the control unit 160 performs a normal program recording in step S109, i.e. records the broadcast data regardless of whether it is the program data or the advertisement data.

If the advertisement skip option is on, the control unit 160 receives the broadcast data in step S111 determines whether the broadcast data includes advertisement data in step S113. If any advertisement data is received, the control unit 160 stops recording the broadcast data to skip the advertisement data in step S115 and waits until the advertisement data reception ends in step S117. When the advertisement data reception ends, the control unit 160 restarts recording the broadcast data from the time point at which the program data recording is stopped in step S119. If it is determined no advertisement data is received in step S113, the control unit 160 skips steps S115 and S117 and maintains recording the program data in step S119.

While recording the broadcast data, the control unit 160 determines whether the current time is the end time of the program in step S121. If the current time is the end time of the program, the control unit 160 terminates the reserved program recording; otherwise, the control unit 160 repeats step S111. The program recording can be performed as a background process. In this case, the broadcast program image is not displayed on the screen of the mobile device.

As described above, the advertisement-free program recording method according to this embodiment can record the program data without the advertisement data.

FIG. 5 is a flowchart illustrating an advertisement-free real time program recording method according to another preferred embodiment of the present invention. In this embodiment, it is assumed that the broadcast receiver unit is active to receive the broadcast data.

Referring to FIG. 5, the mobile device 100 receives the broadcast data in step S201 and determines whether a recording key input is detected in step S203 while receiving the broadcast data. If no recording key input is detected, the mobile device 100 maintains receiving and processing the broadcast data to be output in step S205. The broadcast data may include advertisement data as well as program data. Video data of the advertisement and program are output via the display unit 150 and audio data of the advertisement and program are output via the audio processing unit 130. The output of the video and audio data can be either maintained during the whole recording session or stopped while maintaining the recording. If a recording key input is detected in step S203, the mobile device 100 checks whether the advertisement skip option 1o is active in step S207. If the advertisement skip option is off, the mobile device 100 starts recording the broadcast data in the normal recording process in step S209. In this case, the recorded broadcast data may contain the advertisement data as well as the program data.

If the advertisement skip option is on, the mobile device 100 determines whether any advertisement data is detected while receiving the broadcast data in step S211. If advertisement data is detected, the mobile device 100 stops recording the broadcast data while maintaining the output of the advertisement data to the display unit 150 and the audio processing unit 130. Next, the mobile device 100 waits until the reception of the advertisement data ends in step S215. If the reception of the advertisement data ends, the mobile device restarts recording the broadcast data in step S217.

In the meantime, if no advertisement data is detected in step S211, the mobile device 100 skips steps S213 and S215 and continues recording the broadcast data in step S217.

While recording the broadcast data, the mobile device 100 determines whether a recording stop key input is detected in step S219. If no recording stop key input is detected, the mobile device 100 repeats step S211. Otherwise, recording is stopped.

As described above, the advertisement-free real time program recording method of this embodiment can skip the advertisement while recoding the broadcast data with the active advertisement skip option, whereby only the program data are recorded without engagement of the advertisement data.

Although the advertisement-free program recording method is implemented to record only the program data, the present invention is not limited thereto. For example, the present invention can be implemented such that only the advertisement data are recorded. In this case, the mobile device can be configured to record the advertisement data detected in the broadcast data received in a reserved recording duration.

As described above, the advertisement-free program recording method and system of the present invention enables recording a broadcast program without commercial advertisements, thereby improving user convenience and device usability.

While the invention has been shown and described with reference to certain preferred embodiments of the present invention thereof, it will be understood by those skilled in the art that various changes in form and details may be made therein without departing from the spirit and scope of the present invention as defined by the appended claims and their equivalents.

What is claimed is:

1. A program recording method of a mobile device, the method comprising the steps of:
reserving duration of one of time and a program to be recorded;
receiving broadcast data in the duration;
recording the received broadcast data;
determining whether advertisement data is detected in the received broadcast data;
stopping recording the broadcast data when the advertisement data is detected; and
restarting recording the broadcast data when no advertisement data is detected.

2. The program recording method of claim 1, further comprising turning on an advertisement skip option to skip recording the advertisement data.

3. The program recording method of claim 1, wherein determining whether advertisement data is detected comprises:
determining whether a splice countdown is detected in a header of a packet containing the broadcast data;
regarding packets received after a number of packets indicated by the splice countdown as advertisement data packets;
counting down the number of the broadcast data packets; and
stopping recording the broadcast data after reception of a number of packets.

4. The program recording method of claim 3, wherein restarting recording the broadcast data comprises:
determining whether a splice countdown is detected in a header of the advertisement data packet;
regarding the packet received after a number of the advertisement data packet indicated by the splice countdown as program data packets, if a splice countdown is detected in a header of the advertisement data packet;
counting down the number of the advertisement data packet; and
recording program data packets following the advertisement data packets.

5. The program recording method of claim 1, wherein determining whether advertisement data is detected comprises:
determining event identifiers carried by the broadcast data;
regarding the broadcast data carrying a first event identifier as program data and the broadcast data carrying a second event identifier as the advertisement data, if two different event identifiers are detected;
determining a start time and an end time of the advertisement data with reference to the second identifier; and
stopping recording the broadcast data between the start time and the end time of the advertisement data.

6. The program recording method of claim 5, wherein restarting recording the broadcast data comprises:
Comparing contents nibbles of the first and third event identifiers, if a third event identifier is detected during the start time and the end time of the advertisement data; and
recording, when the first and the third event identifiers are identical with each other, the broadcast data carrying the third event identifier.

7. A program recording method of a mobile device, the method comprising the steps of:
receiving and outputting broadcast data;
detecting a recording key input while receiving and outputting the broadcast data;
recording the broadcast data, when the recording key input is detected;
determining whether advertisement data is received, when an advertisement skip option is turned on;
stopping recording the broadcast data, when the advertisement data is received; and
restarting recording the broadcast data, when the advertisement data is not received.

8. The program recording method of claim 7, wherein determining whether advertisement data is received comprises:
determining whether a splice countdown is detected in a header of a packet containing the broadcast data;
regarding packets received after a number of packets indicated by the splice countdown as advertisement data packets, when the splice countdown is detected;
counting down the number of the broadcast data packets; and
stopping recording the broadcast data after reception of a number of packets.

9. The program recording method of claim 8, wherein restarting recording the broadcast data comprises:
determining whether a splice countdown is detected in a header of the advertisement data packet;
regarding the packet received after a number of the advertisement data packet indicated by the splice countdown as program data packets, if a splice countdown is detected in a header of the advertisement data packet;
counting down the number of the advertisement data packets; and
recording program data packets following the advertisement data packets.

10. The program recording method of claim 7, wherein determining whether advertisement data is received comprises:
determining event identifiers carried by the broadcast data;
regarding, if two different event identifiers are detected, the broadcast data carrying a first event identifier as program data and the broadcast data carrying a second event identifier as the advertisement data;
determining a start time and an end time of the advertisement data with reference to the second identifier; and
stopping recording the broadcast data between the start time and the end time of the advertisement data.

11. The program recording method of claim 10, wherein restarting recording the broadcast data comprises:
comparing, if a third event identifier is detected during the start time and the end time of the advertisement data, contents nibbles of the first and the third event identifiers; and
recording, when the first and the third event identifiers are identical with each other, the broadcast data carrying the third event identifier.

12. A mobile device comprising:
a broadcast receiver unit for receiving broadcast data including program data and advertisement data;
a control unit for recording the program data of the broadcast data from which the advertisement data is excluded; and
a memory unit for buffering the broadcast data and storing the program data.

13. The mobile device of claim 12, wherein the memory unit stores reserved recording information on a program to be recorded.

14. The mobile device of claim 13, wherein the reserved recording information comprises at least one of a recording duration and a program identifier and a channel on which the program data to be recorded is broadcasted.

15. The mobile device of claim 12, further comprising an input unit for generating a recording command signal to start recording currently received broadcast data and a recording stop command signal to stop recording the broadcast data.

16. The mobile device of claim 12, wherein the control unit determines whether a splice countdown is detected in a header of a packet containing the broadcast data, regards packets received after a number of packets indicated by the splice countdown as advertisement data packets, when the splice countdown is detected, counts down the number of broadcast data packets, and stops recording the broadcast data after reception of a number of packets.

17. The mobile device of claim 16, wherein the control unit determines whether a splice countdown is detected in a header of the advertisement data packet, regards the packet received after a number of the advertisement data packet indicated by the splice countdown as program data packets, if a splice countdown is detected in a header of the advertisement data packet, counts down the number of the advertisement data packets, and records program data packets following the advertisement data packets.

18. The mobile device of claim 12, wherein the control unit determines event identifiers contained in a service information table carried by the broadcast data, regards the broadcast data carrying a first event identifier as program data and the broadcast data carrying a second event identifier as the advertisement data, if two different event identifiers are detected, determines a start time and an end time of the advertisement data with reference to the second identifier, and stops recording the broadcast data between the start time and the end time of the advertisement data.

19. The mobile device of claim 18, wherein the control unit compares, if a third event identifier is detected during the start time and the end time of the advertisement data, contents nibbles of the first and third event identifiers, and records the broadcast data carrying the third event identifier, when the first and third event identifiers are identical with each other.
